(19) United States
(12) Patent Application Publication
(10) Pub. No.: US 2024/0385447 A1
(43) Pub. Date: Nov. 21, 2024

(54) OPTICAL DISPLAY SYSTEM BASED ON SELF-LUMINOUS DISPLAY CHIPS AND LIGHT WAVEGUIDES

(71) Applicant: SHENZHEN PHOTONIC CRYSTAL TECHNOLOGY CO., LTD, SHENZHEN (CN)

(72) Inventors: YONGJING WANG, SHENZHEN (CN); YUHUA WANG, SHENZHEN (CN); WEIMIN JIANG, SHENZHEN (CN); GANG ZHENG, SHENZHEN (CN); XIYU ZHANG, SHENZHEN (CN); QINGYOU NONG, SHENZHEN (CN)

(21) Appl. No.: 18/786,457

(22) Filed: Jul. 27, 2024

Related U.S. Application Data
(63) Continuation of application No. PCT/CN2022/074639, filed on Jan. 28, 2022.

(51) Int. Cl. G02B 27/01; G02B 6/34; G02B 6/42

(52) U.S. Cl. CPC G02B 27/0172; G02B 6/34; G02B 6/42; G02B 6/4206; G02B 2027/0112

(57) ABSTRACT

The invention discloses an optical display system based on a self-luminous display chip and light waveguides. The coupling-in and/or coupling-out devices each include a set of light combining devices, allowing the red, green, and blue display regions at different positions to coincide, forming a full-color image. The technical solution of this application overcomes the difficulty of forming red, green, and blue sub-pixels separately on the self-luminous display chip, enabling the realization of a high-resolution, ultra-compact display device.

### CROSS REFERENCE TO RELATED APPLICATION

This application is a continuation of International Patent Application No. PCT/CN2022/074639 with a filing date of Jan. 28, 2022, designating the United States, now pending. The content of the aforementioned applications, including any intervening amendments thereto, are incorporated herein by reference.

### TECHNICAL FIELD

The present invention relates to the field of optical display technology, particularly to an optical display system based on self-luminous display chips and light waveguides.

### BACKGROUND TECHNOLOGY

The present invention is a continuation of U.S. Patent U.S. Pat. No. 8,845,109B2 and Chinese Patent ZL200810123156.3. This patent relates to a self-luminous display system, particularly suitable for a color display system based on light waveguides.

Projection display technology and near-eye display technology using Silicon-based Liquid Crystal on Silicon (LCOS) and Micro-Electro-Mechanical System (MEMS) are considered the future of displays, as they utilize silicon wafers more efficiently than direct-view displays. However, there has not been significant improvement in the optical efficiency and size of projection display technology and near-eye display technology. The primary reason is that these display technologies require separate light sources and microdisplay chips.

Self-luminous display technologies, such as MicroOLED (Micro Organic Light Emitting Diode) and MicroLED (Micro Light Emitting Diode), have rapidly developed in recent years. Significant progress has been made in brightness, efficiency, and control electronics, reaching a level where ultra-bright self-luminous panels can replace microdisplays and light sources in projection systems. MicroLED and MicroOLED use different bandgap and lattice materials to produce different RGB colors. These different materials are challenging to fabricate on the same epitaxial wafer using semiconductor processes. Moreover, generating MicroLEDs on epitaxial wafers requires chip dicing to form monochromatic sub-pixels, followed by a “pick-and-place” process to transfer a large number of sub-pixels to a common electrical backplane to form a full-color display. This process is suitable for larger direct-view displays but is challenging for projection or near-eye (NTE) displays that require ultra-high resolution. The massive pixel transfer (pick-and-place) process is difficult for microdisplays requiring sub-10-micron color pixels, making it challenging to use MicroLED and MicroOLED for projection systems and near-eye AR/VR systems.

We developed a new projection light engine architecture called Angular Color Projection (ACP), which uses a single panel to display red, green, and blue information in spatially separated color regions. U.S. Patent U.S. Pat. No. 8,845,109B2 and Chinese Patent ZL200810123156.3 have been successfully applied in projection systems with independent light sources.

In this invention, we propose a high-resolution, ultra-compact optical structure using light waveguides for projection systems and near-eye (NTE) display systems based on self-luminous display chips and light waveguides.

### SUMMARY OF THE INVENTION

The objective of the present invention is to overcome the shortcomings of the prior art by providing an optical display system based on self-luminous display chips and light waveguides, which overcomes the difficulty of forming red, green, and blue sub-pixels on self-luminous display chips, thus achieving high-resolution and ultra-compact display devices.

To achieve the above objective, the present invention is realized through the following technical solutions. The invention discloses an optical display system based on self-luminous display chips and light waveguides. Specifically, it includes:

1) One or more self-luminous display chips. The self-luminous display chips can be Micro LED display chips or Micro OLED display chips. Unlike traditional Micro LED display chips where the red, green, and blue sub-pixels are separate, the display chips used in this invention group red, green, and blue pixels together to form three or more red, green, and blue regions, each region comprising multiple pixels. This chip can include multiple red, green, and blue regions on a single driving backplane, or it can include three separate luminous chips controlled by three separate driving backplanes. These luminous chips are installed in close proximity on a single plane or multiple planes;

2) One or more optical display systems for imaging the light from the red, green, and blue regions;

3) One or more coupling devices for coupling the light from the red, green, and blue regions into one or more light waveguides;

4) One or more light waveguides;

5) One or more coupling-out devices for coupling out the light beams that have propagated a certain distance through the light waveguide, combining them into a full-color image and directing it into the observer's pupil. Due to the different positions of the red, green, and blue images, the coupling-in device and/or the coupling-out device further includes one or more light combining devices to combine the light from different positions of the red, green, and blue regions into a full-color image.

In one possible implementation of this application, the self-luminous display chip is one of Micro LED and Micro OLED.

In one possible implementation of this application, the red, green, and blue display regions are on the same display chip.

In one possible implementation of this application, the red, green, and blue display regions are on different display chips, which are arranged side by side and close enough to form a plane.

In one possible implementation of this application, the red, green, and blue display regions are on different display chips, and these different display chips are arranged on three sides of a light combining prism.

The display chip may include three adjacent red, green, and blue color regions, and the optical display system combines the red, green, and blue regions into a full-color image. The red, green, and blue regions may be located on the same electronic driving backplane or on three separate panels. The light combining device uses diffractive elements or holographic elements or dichroic mirrors in the optical display system to reflect light beams of different colors at different angles, thereby combining the red, green, and blue into a full-color image.

In one possible implementation of this application, the coupling device is one or more diffractive optical elements, whose period is designed to deflect the red, green, and blue light at different angles so that the light forms a full-color image when coupled out.

In one possible implementation of this application, the coupling device further includes multiple dichroic mirror layers, which deflect the red, green, and blue light at different angles so that the light forms a full-color image when coupled out.

In one possible implementation of this application, the coupling-out device consists of one or more diffractive optical elements. The periodicity of these diffractive optical elements is designed to deflect red, green, and blue light at different angles, thereby combining the light into a full-color image upon exiting.

Preferably, in the coupling-in and coupling-out devices, at least one utilizes a diffractive device. The diffractive device includes elements such as gratings or holograms. The periodicity of these diffractive elements is adjusted to diffract red, green, and blue light at different angles, ensuring that the light rays converge to produce a full-color virtual image upon exit.

Preferably, the coupling-in device includes a prism that is equipped with at least three reflecting surfaces for red, green, and blue light. These reflecting surfaces can be achieved using dichroic mirrors, where each mirror reflects only a specific color: the first dichroic mirror reflects red light, the second reflects green light, and the third reflects blue light. These dichroic mirrors are controlled at different angles to converge the reflected red, green, and blue light rays together.

In one possible implementation of the present invention, there is further included a beam combiner prism. A typical beam combiner prism would fully overlap the light from the red, green, and blue chips into a single colored light. However, the light from the red, green, and blue chips does not fully overlap after passing through the beam combiner prism; there is some degree of separation. This separation degree compensates for the dispersion of red, green, and blue colors by the optical waveguide, enabling dispersion-free color display with a single-layer optical waveguide using the same diffraction element.

In one possible implementation of the present application, the coupling-out device is a diffractive optical waveguide or an arrayed optical waveguide.

In one possible implementation of the present application, the optical waveguide is a single-layer optical waveguide, where one waveguide is used for the three different colors of red, green, and blue. In an embodiment within a single-layer optical waveguide, the coupling-in device includes multiple dichroic mirrors oriented in different directions, which deflect colored light from different regions to different angles, combining them to form a full-color image.

In another possible implementation within a single-layer optical waveguide, diffractive or holographic elements are employed in the coupling-in and coupling-out devices. These elements have different deflection angles for red, green, and blue light of different wavelengths. The period of these diffractive or holographic elements correlates with the separation distance of the red, green, and blue regions in the microdisplay chip. Detailed design according to predefined requirements is necessary to achieve appropriate deflection directions for the diffractive or holographic elements, ensuring the alignment of red, green, and blue colors to form a full-color image.

In one possible implementation within this application, the optical waveguides are arranged parallel to each other and stacked together.

In one possible implementation within this application, three optical waveguides are stacked together, with red, green, and blue lights respectively entering each of the three waveguides. Each waveguide contains a combining device that merges the three colors of light into a full-color image.

Preferably, the combining device is a dichroic mirror.

Preferably, the combining device can be a diffractive optical element.

The optical architecture of existing AR glasses often relies on optical waveguides, where diffractive optical elements are used as coupling or output components. However, due to the wavelength-dependent nature of diffractive optical elements, significant chromatic dispersion exists. To address this dispersion issue, many products have had to adopt three-layer optical waveguides, resulting in higher volume and cost.

In one possible implementation described in this application, one or more of the optical display systems further include an optical image processing device. This device preprocesses the red, green, and blue light images to ensure their final alignment and overlap.

The precise alignment of the red, green, and blue color images must be accurate to less than one pixel. To further enhance this alignment accuracy, in another possible implementation described in this invention, it may also include an electronic calibration device. This electronic calibration device preprocesses each frame of the red, green, and blue images with specific adjustments, ensuring that the final red, green, and blue images align perfectly to form a color image.

This application can achieve a pixel size of 4 to 6 micrometers for ultra-high-resolution microdisplays. This higher resolution not only produces clearer images but also results in smaller panels, thereby creating more compact optics. These attributes are crucial for projection and near-eye AR/VR applications. Since all electrodes and circuits can be manufactured using traditional semiconductor processes, the resolution of the display system is limited only by the edge effects of the Micro LED substrate and the design of the optical display system.

The proposed technology in this application is based on optical waveguides and self-emissive display chips, overcoming the challenges of separately forming red, green, and blue sub-pixels on self-emissive display chips. This technology enables high-resolution, ultra-compact display devices suitable for near-eye applications, including AR glasses and VR goggles, as well as automotive head-up displays and micro-projectors.

### FIGURE CAPTION

Please refer to the figures below for a more detailed description of embodiments of the present invention. They show:

FIG. 1 illustrates a schematic diagram of an optical display system based on optical waveguides and one or more emissive display chips.

FIG. 2 depicts a schematic diagram of an optical display system based on optical waveguides and multiple emissive display chips.

FIG. 3 shows another schematic diagram of an optical display system based on optical waveguides and multiple emissive display chips.

FIG. 4 presents a schematic diagram of an optical display system based on optical waveguides and three emissive display chips.

FIG. 5 presents another schematic diagram of an optical display system based on optical waveguides and one or more emissive display chips.

### DETAILED EMBODIMENTS

Further detailed description of the optical display system based on emissive display chips and optical waveguides, in conjunction with the accompanying drawings and specific embodiments of the present invention. Based on the following description and claims, the advantages and features of the present invention will become clearer.

The emissive display chip eliminates the process of dividing and ‘pick and place’ of individual color pixels (sized in micrometers), replacing them with colored sub-regions (sub-panels) where the size of each sub-region is in millimeters. Different colored regions can easily be transferred onto a common driving backplane. Furthermore, for a colored sub-panel, pixel structures can be directly formed by patterning electrodes using semiconductor processes, eliminating the need for pixel chip segmentation. Therefore, the resolution of colored chips is significantly enhanced, achieving 2 micrometers or smaller.

In some embodiments of the present application, emissive display chips can encompass any emissive display technology, including but not limited to Micro LED, Micro OLED, and other emissive technologies known in the industry, without limitation to those specifically mentioned.

### Implementation Example 1

Specifically, FIG. 1 of the present application illustrates a schematic diagram of an optical display system based on optical waveguides and one or more emissive display chips. The optical display system comprises:

1) One or more emissive display chips 10. The emissive display chips can be Micro LED display chips or Micro OLED display chips. Unlike traditional Micro LED display chips where red, green, and blue sub-pixels are separate, the display chips used in the present invention aggregate pixels of red, green, and blue into three or more distinct regions 101, 102, 103, each region comprising multiple pixels. This chip can be composed of multiple red, green, and blue regions on a single driving backplane or three separate emissive chips controlled by separate driving backplanes. These emissive chips are mounted on a single plane or multiple planes in close proximity.

2) One or more optical display systems 11, which image the light from the red, green, and blue regions.

3) A diffraction optical coupling-in device 12 that couples the light of red, green, and blue into an optical waveguide.

4) An optical waveguide 13.

5) A diffraction optical coupling-out device 14 that couples the light beams propagated through the optical waveguide over a certain distance out of the waveguide, into the observer's pupil.

Due to the different positions of the images of red, green, and blue light, the grating period in the diffraction optical coupling-in and/or coupling-out devices is designed to diffract the light rays (131, 132, 133) of red, green, and blue at different angles. After propagating through the optical waveguide and coupling out, the red, green, and blue light from different positions ultimately combine to form a full-color image 15.

### Implementation Example 2

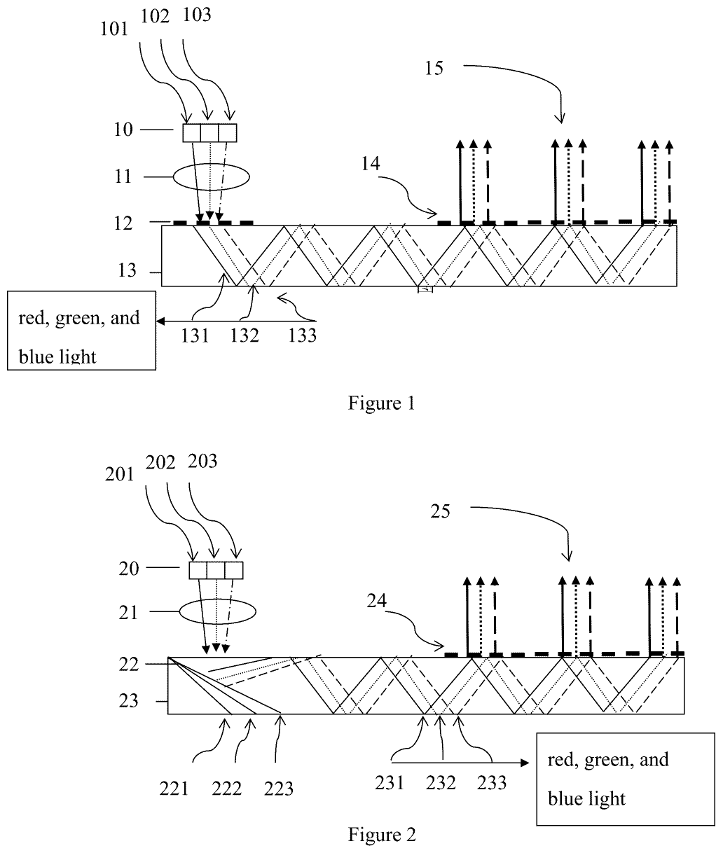

Specifically, FIG. 2 of the present invention illustrates a schematic diagram of an optical display system based on optical waveguides and multiple emissive display chips, comprising:

1) Multiple emissive display chips 20. Three emissive display chips for red, green, and blue are denoted as 201, 202, and 203.

2) One or more optical display systems 21 that image the light from the red, green, and blue regions.

3) A prism coupling-in device 22, which includes a prism with at least three reflective surfaces dedicated to red, green, and blue. These reflective surfaces can be implemented using dichroic mirrors, where the first dichroic mirror 221 reflects only red light, the second dichroic mirror 222 reflects only green light, and the third dichroic mirror 223 reflects blue light. These dichroic mirrors are controlled at different angles to overlap the reflected red, green, and blue light beams 25. Additionally, FIG. 2 shows a possible arrangement of the dichroic mirrors 231, 232, 233 for the red, green, and blue colors, which can be adjusted according to practical usage without limitation.

4) An optical waveguide 23.

5) A diffraction optical coupling-out device 24 that couples the light beams propagated through the optical waveguide over a certain distance out of the waveguide and into the observer's pupil.

Due to the different positions of the images of red, green, and blue light, the dichroic mirrors reflect the light rays (231, 232, 233) of red, green, and blue at different angles, thereby combining the light from different positions into a full-color image 25.

### Implementation Example 3

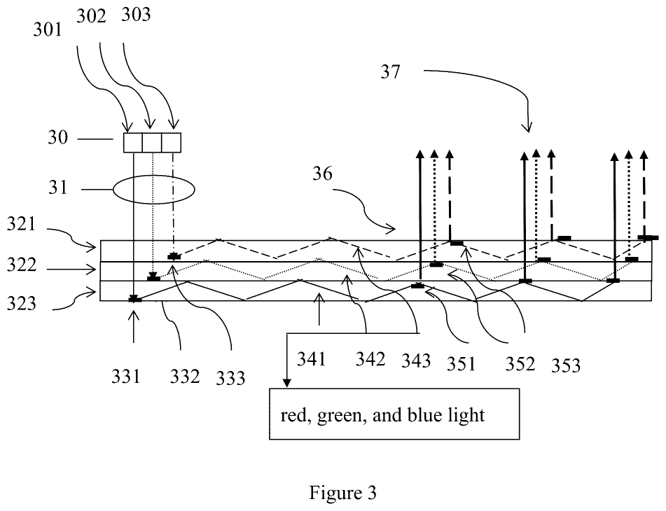

Specifically, FIG. 3 of the present invention illustrates another schematic diagram of an optical display system based on optical waveguides and multiple emissive display chips, comprising:

1) Multiple emissive display chips 30. Three emissive display chips for red, green, and blue are denoted as 301, 302, and 303.

2) One or more optical display systems 31 that image the light from the red, green, and blue regions.

3) Three coupling-in devices 331, 332, 333, which respectively import the red, green, and blue light from 301, 302, 303.

4) Three optical waveguides 321, 322, 323 into which the imported light is directed.

5) Three diffraction optical coupling-out devices 351, 352, 353, directing light beams into the observer's pupil. Due to the different positions of the images of red, green, and blue light, the coupling-in and coupling-out devices reflect the light rays (341, 342, 343) of red, green, and blue at different angles, thereby combining the light from different positions into a full-color image 37.

Implementation Example 4

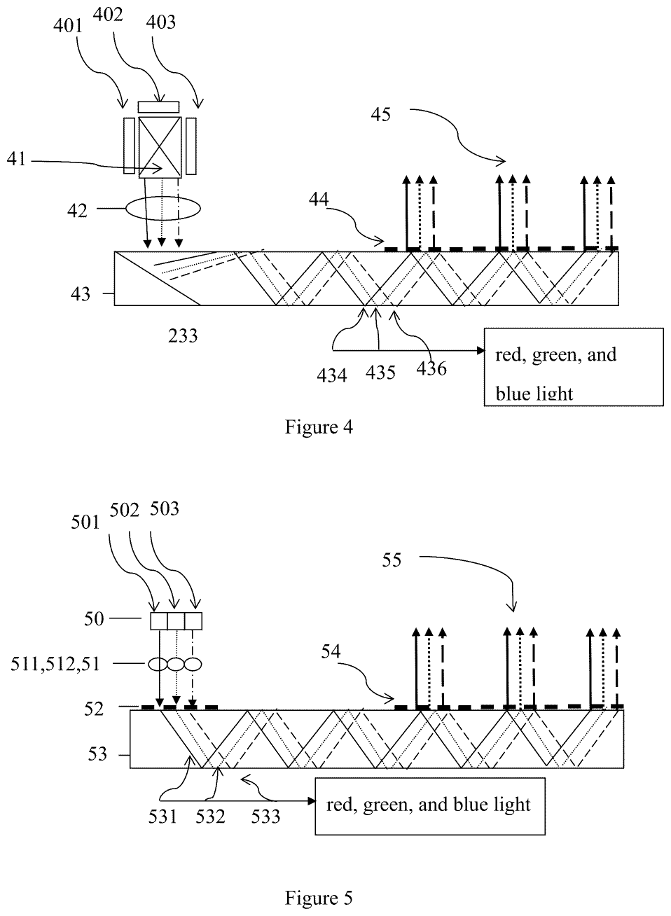

Specifically, FIG. 4 of the present invention illustrates a schematic diagram of an optical display system based on optical waveguides and three emissive display chips, comprising:

1) Three emissive display chips 401, 402, 403, corresponding to red, green, and blue colors respectively.

2) A combiner prism 41 that aligns the red, green, and blue light to the required degree.

3) One or more optical display systems 42 that image the light from the red, green, and blue regions.

4) One coupling-in device 233 that imports the red, green, and blue light from 401, 402, and 403 into the optical waveguide 43.

5) One diffraction optical coupling-out device 44 that directs light beams out of the optical waveguide into the observer's pupil.

The emitted light from the red, green, and blue chips passes through the combiner prism 41 and is not completely overlapped, showing some degree of separation. This separation is compensated by the optical waveguide for the dispersion of red, green, and blue colors, achieving dispersion-free color display using a single-layer optical waveguide and the same diffraction element. Due to the different positions of the images of red, green, and blue light, the coupling-in and coupling-out devices reflect the light rays (434, 435, 436) of red, green, and blue at different angles, thereby combining the light from different positions into a full-color image 45.

### Implementation Example 5

Specifically, FIG. 5 of the present invention depicts a schematic diagram of an optical display system based on optical waveguides and one or more emissive display chips, comprising:

1) One or more emissive display chips 50, where pixels of red, green, and blue are clustered together into three regions: 501, 502, 503.

2) Three optical display systems 511, 512, 513 that respectively image the light from the red, green, and blue regions. Additionally, the red, green, and blue regions may include multiple regions corresponding to the imaging by optical display systems, without limitation.

3) A diffraction optical coupling-in device 52 that couples the light of red, green, and blue into an optical waveguide.

4) An optical waveguide 53.

5) A diffraction optical coupling-out device 54 that couples out light beams propagated through the optical waveguide to enter the observer's pupil.

Due to the different positions of the images of red, green, and blue light, the diffraction grating period in the diffraction optical coupling-in and/or coupling-out devices is designed to diffract the light rays (531, 532, 533) of red, green, and blue at different angles, thereby combining light from different positions into a full-color image 55.

Through the above embodiments, the color display technology based on optical waveguides and emissive display chips overcomes the challenges of separately forming red, green, and blue sub-pixels on emissive display chips. This technology enables high-resolution, ultra-compact display devices suitable for near-eye displays, including AR glasses and VR headsets, as well as for automotive head-up displays and micro-projectors.

The above detailed description, combined with the accompanying drawings, illustrates exemplary embodiments of the present invention. However, the present invention is not limited to the above embodiments. Within the knowledge scope of ordinary skilled artisans in the relevant technical field, various changes can be made without departing from the spirit of the invention. Additionally, features of embodiments of the present invention can be combined with each other as long as they do not conflict.

This optical display system has: 1) one or more self-luminous display chips, where red, green, and blue pixels are respectively grouped together to form three or more color display regions; 2) one or more optical display systems for imaging the light from the red, green, and blue regions; 3) one or more coupling devices for coupling the light from the red, green, and blue display regions into one or more light waveguides; 4) one or more light waveguides stacked together; 5) one or more coupling-out devices for coupling out the light beams that have propagated a certain distance through the light waveguides, directing them into the observer's pupils.

We claim:

1. An optical display system comprises:
1) one or more self-luminous display chips, wherein red, green, and blue pixels are respectively grouped together to form three or more red, green, and blue regions;
2) one or more optical display systems for imaging the light from the red, green, and blue regions;
3) one or more coupling devices for coupling the light from the red, green, and blue regions into one or more light waveguides;
4) one or more light waveguide lenses;
5) one or more coupling-out devices for coupling out the light beams that have propagated a certain distance through the light waveguides, directing them into the observer's pupils; wherein the coupling-in and/or coupling-out further includes: one or more light combining devices for combining the light from the red, green, and blue regions at different positions to form a full-color image.

2. The optical display system according to claim 1, wherein the self-luminous display chip is one of Micro LED and Micro OLED.

3. The optical display system according to claim 1, wherein the red, green, and blue display regions are on the same display chip.

4. The optical display system according to claim 1, wherein the red, green, and blue display regions are on different display chips, which are arranged side by side close enough to form a plane.

5. The optical display system according to claim 1, wherein the red, green, and blue display regions are on different display chips, which are arranged on three sides of a light combining prism.

6. The optical display system according to claim 1, wherein the coupling device is one or more diffractive optical elements, whose period is designed to deflect the red, green, and blue light at different angles, so that the light forms a full-color image when coupled out.

7. The optical display system according to claim 1, wherein the coupling device further comprises multiple dichroic mirrors, which deflect the red, green, and blue light at different angles, so that the light forms a full-color image when coupled out.

8. The optical display system according to claim 1, wherein the coupling-out device is one or more diffractive optical elements, whose period is designed to deflect the red, green, and blue light at different angles, so that the light forms a full-color image when coupled out.

9. The optical display system according to claim 1, wherein the coupling-out device is a diffractive waveguide or an array waveguide.

10. The optical display system according to claim 1, wherein the light waveguide is a single layer light waveguide.

11. The optical display system according to claim 1, wherein the light waveguide is multiple light waveguides arranged parallel to each other and stacked together.

12. The optical display system according to claim 1, wherein one or more of the optical display systems further comprise: an optical image processing device for pre-processing the red, green, and blue light images, so that the red, green, and blue images are finally coincident.
